(19) United States
(12) Patent Application Publication
(10) Pub. No.: US 2007/0055980 A1
(43) Pub. Date: Mar. 8, 2007

(54) Method for the uninterrupted display of television programs with suppressed program segments

(76) Inventors: Magdy Megeid, Zurich (CH); Germano Covazzi, Zurich (CH)

Correspondence Address: THOMSON LICENSING INC., PATENT OPERATIONS, PO BOX 5312, PRINCETON, NJ, 08543-5312, US

(21) Appl. No.: 10/529,933

(22) PCT Filed: Oct. 10, 2003
(86) PCT No.: PCT/EP03/11241

§ 371 Date: Mar. 31, 2005

Related U.S. Application Data
(60) Provisional application No. 60/417,609, filed on Oct. 10, 2002.
(60) Provisional application No. 60/417,609, filed on Oct. 10, 2002.

(51) Int. Cl. H04N 7/025; H04N 7/10

(52) U.S. Cl. 725/28; 725/27; 725/32

(57) ABSTRACT

A method for selectively suppressing undesired program segments from a broadcast television signal is provided. Program information is received from a service provider and includes program segment specific content rating information which is compared with stored user defined preferences. When the user preferences indicate an undesired program content (e.g., violence, sexual situations, etc.), a time compensation factor is calculated to remove the undesired program segments and display the program uninterrupted to the user without the unwanted material. The time compensation can be in the form of a delayed program start, extension of desired segments, or a combination of both.

### FIELD OF THE INVENTION

The present invention generally relates to television broadcast systems, and, more particularly, to a method for suppressing predetermined program segments from a transmitted television programming.

### BACKGROUND OF THE INVENTION

When watching television, often times there is subject matter in the broadcast that is undesirable to one or more of the viewers in the room. In an effort to provide the viewer with more control over what they are viewing, program providers have implemented a rating system, whereby the content of the entire program is rated on a predetermined scale.

Some program providers include “closed-captioning” information in their analog signal for processing by the “V-chip”. This chip suppresses the entire display of the program based on a rating scale if the received rating coincides with the rating previously entered by a user. The V-chip only permits the suppression of an entire program.

Video compression such as MPEG4, MPEG-2 and, to a lesser degree, MPEG-2 offer the possibility to include detailed information about the content of the transmitted program. The more detailed information present in a digital signal allows for the possibility of removing certain undesired parts or program segments from the transmitted signal. However, suppression of the received program portions in real time results in interruptions of the program.

Examples of programs where it may be desirable for a parent or other guardian to suppress program segments are programs containing violence, sexual situations, advertisements, etc. Without these segments, the program would otherwise be considered normal or acceptable for the viewer to watch.

It is therefore desirable to provide a method for suppressing program segments without suppressing the entire program and without interrupting the continuous viewing of the transmitted signal.

### SUMMARY OF THE INVENTION

It is therefore an object of the invention to provide a method for suppressing program segments without interrupting the viewing of the transmitted signal.

This and other objects are achieved in accordance with an embodiment of the invention wherein the method for suppressing undesired program segments from a broadcast program includes receiving program information from a service provider, determining whether undesired program segments are present in the received program information, and modifying the displayed program to eliminate the undesired program segments.

In accordance with other aspects of the invention, the method for suppressing undesired program segments from a broadcast program includes an initial step of determining if a program control mode has been activated. Once activated, program information relating to the program content from the service provider is loaded. With the program information loaded, and previously stored user preferences, it is readily discernible to identify whether undesired program segments are present in the received program information.

When undesired program segment are present, a time compensation factor is calculated for the same. In accordance with one aspect of the invention, the time compensation factor is used to delay the start of the program so as to provide uninterrupted display of the program with all of the undesired program segments removed.

In accordance with another aspect of the invention, the identified undesirable program segments are used to calculate time extension factors for the immediately preceding desired program segment.

When the immediately preceding desired program segment has a time duration that is greater than or equal to a fractional computation of both the undesired program segment and the immediately preceding desired program segment, the undesired program segment is removed and the preceding desired program segment is extended by a predetermined amount of time.

According to yet another aspect of the invention, the method for suppressing undesired program segments from a broadcast program includes the steps of determining if a program control mode has been activated, loading program information relating to the program content from the service provider when the program control mode has been activated, identifying whether undesired program segments are present in the received program information, determining whether desired program segments can be extended to compensate for removal of the undesired program segments, calculating a time compensation factor for removing the undesired program segments, and displaying the program to the user uninterrupted with all of the undesired program segments removed.

### BRIEF DESCRIPTION OF THE DRAWINGS

The advantages, nature, and various additional features of the invention will appear more fully upon consideration of the illustrative embodiments now to be described in detail in connection with accompanying drawings wherein:

FIG. 1a is a timing diagram of the program parts of an exemplary transmitted signal by a program provider according to an embodiment of the invention;

FIG. 1b is a program table identifying the various program parts of the transmitted program signal of FIG. 1a;

FIG. 2 is a flow diagram of the method for the delayed display mode according to an embodiment of the invention;

FIG. 3 is a timing diagram a program after delayed display mode has been selected according to an embodiment of the invention;

FIG. 4 is a flow diagram of the method for the time extended display mode according to an embodiment of the invention; and

FIG. 5 is a timing diagram of the program after time extended display has been selected according to an embodiment of the invention.

It should be understood that the drawings are for purposes of illustrating the concepts of the invention and are not necessarily the only possible configuration for illustrating the invention.

### DETAILED DESCRIPTION OF THE INVENTION

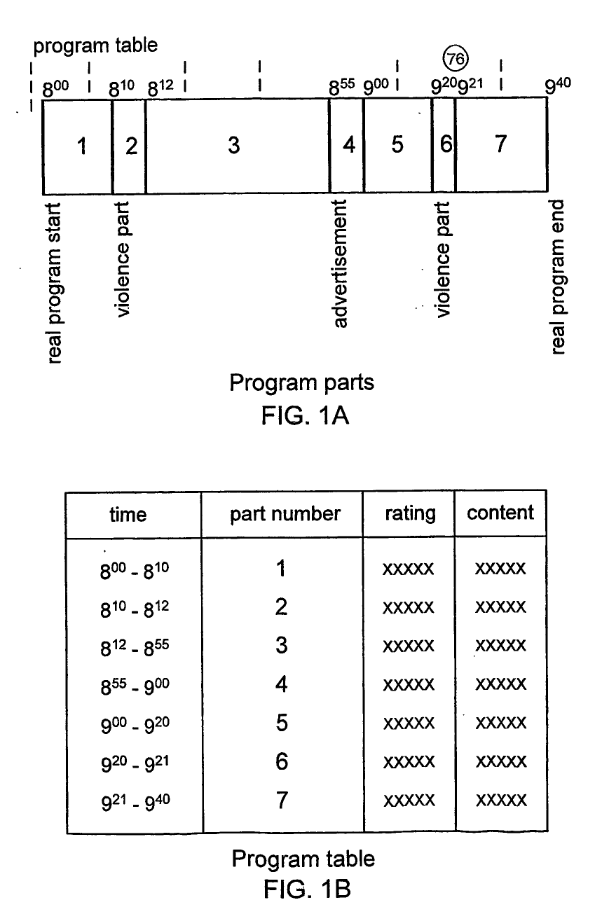

FIG. 1a shows a timing diagram of an entire program broken down into identifiable parts that are transmitted by the program provider. In this example, there are seven parts (1-7) representing content specific points in the program broadcast. The content specific points are identified based on content and a corresponding rating, such as, for example, violence, sexual situations, etc.

As shown, the exemplary program starts and has “violence” parts or scenes at part 2 and 6, and an advertisement interruption at part 4. The remaining parts 1, 3, 5, and 7 are also part of the program but are inconsequential for purposes of identification.

According to an embodiment of the invention, the identification data is transmitted by the program provider in the form of a table which can be easily integrated in the audio/video data stream of the program. FIG. 1b shows an exemplary program table that relates the part numbers (1-7) to the times at which they occur and also includes the part's rating and content identification information.

The present invention is implemented using a digital TV receiver with a large memory, for example a set-top box with a hard disk drive and personal video records (PVR). The viewer selects, with the aid of an on screen menu, the program control mode. In this mode, the user can use the TV ratings to identify undesired content of a program so that it can be removed during reception. Once this user makes their selection, their preferences are stored in receiver. Just before the beginning of the program, the program table (e.g., FIG. 1b) is received and the processing of the delayed display mode of the invention starts.

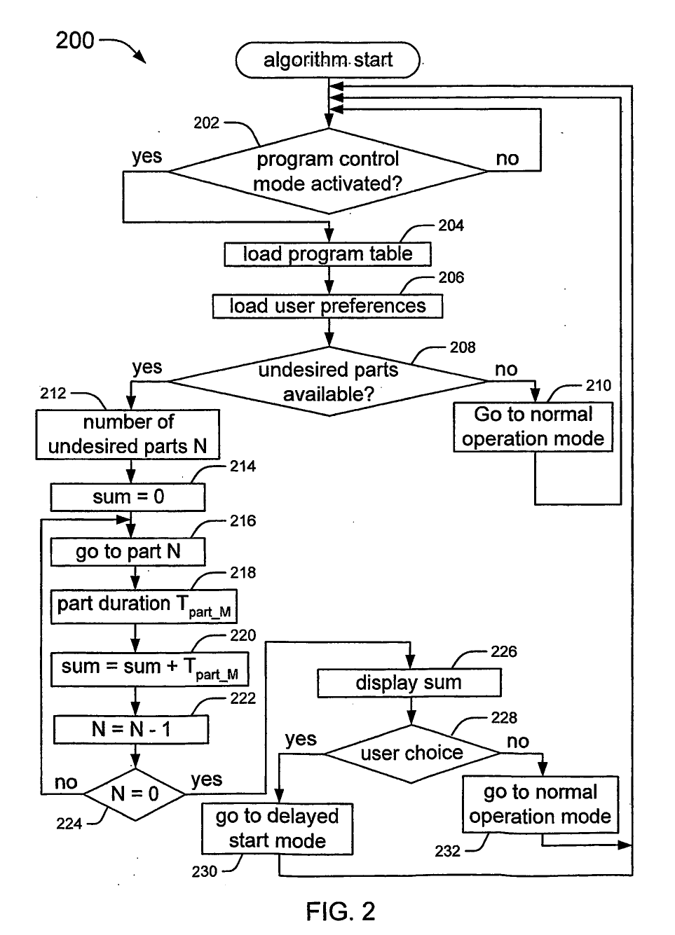

FIG. 2 is a flow diagram of the method 200 of the delayed display mode according to an aspect of the invention. Initially, it is determined whether or not the program control mode has been activated or not (202). If not, the received program table is neglected and the entire program is displayed in a normal operation mode. Otherwise, the program table is captured from the data stream and stored (204). The previously stored user preferences (206) are then compared with the program identification data in the loaded table to determine if any undesired segments have to be removed from the program (208).

The comparison (208) is preferably performed before the program starts. In the absence of such segments, the normal operation mode (210) is entered and the entire program is displayed. Using the program table of FIG. 1b as an example, assume that the user preferences indicate “violence” as undesired. Thus, segments 2 (T_{PART}_{_{—}}₂) and 6 (T_{PART}_{_{—}}₆) require suppression. The number of undesired parts N is assigned (212) according to the previous identification. In this example N=2. Then the parameter Sum is initialized to zero (214) and then the time duration of the last undesired segment M (T_{PART}_{_{—}}₆) is determined (216 and 218). In this example, segment M lasts for 1 minute. This result is stored in parameter SUM (220) and N is reduced by one (222). In this manner, the method keeps looping until the total duration of all undesired segments has been added together with the result in SUM, which is three (3) minutes in the present example (i.e., T_{PART}_{_{—}}₂=(8¹²−8¹⁰)=2 minutes and T_{PART}_{_{—}}₆=(9²¹−9²⁰)=1 minute). When N=0 (224) and there are no more undesired segments for suppression, the SUM=3, (2+1) is displayed (226) to the user. The user is then provided with the option (228) of accepting the delayed start time of the program and entering the delayed start mode (230), or return to the normal (un-suppressed) operation mode (232).

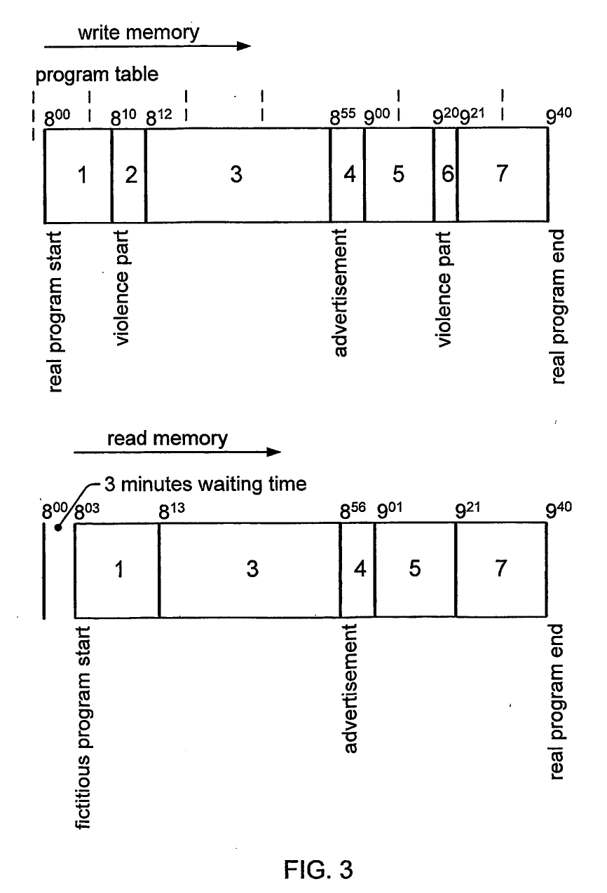

The removal of the actual segments 2 and 6 is only possible during the actual reception of the transmitted signal. As a result, a continuous or seamless display of the program is possible if the start time of the program is delayed by 3 minutes. As shown in FIG. 3, the program is received and written to memory (e.g., HDD) at its schedule time, however the user who selected the delayed mode operation will start watching the program (i.e., reading from memory) 3 minutes later. When the user starts to watch the program 3 minutes later, the algorithm only reads the desired parts from the memory beginning with part 1. Thus, the program is displayed in one piece 3 minutes after the scheduled start of the program.

In this embodiment, the user actually gains 3 minutes of time after the schedule start of the program since the program end remains the same. Thus, in the delayed display mode of the invention, the undesired parts or segments of a program are removed during reception by calculating a new “fictitious” start time for the user. The fictitious start time is equal to the real start time plus the total of undesired parts.

During the three minute wait time resulting from the delayed display mode, the receiver can display a blank screen with or without a countdown timer, or provide audio music or other audio. At the expiration of the 3 minute wait time, the receiver can provide an audible alarm to alert the user as to the start of the program.

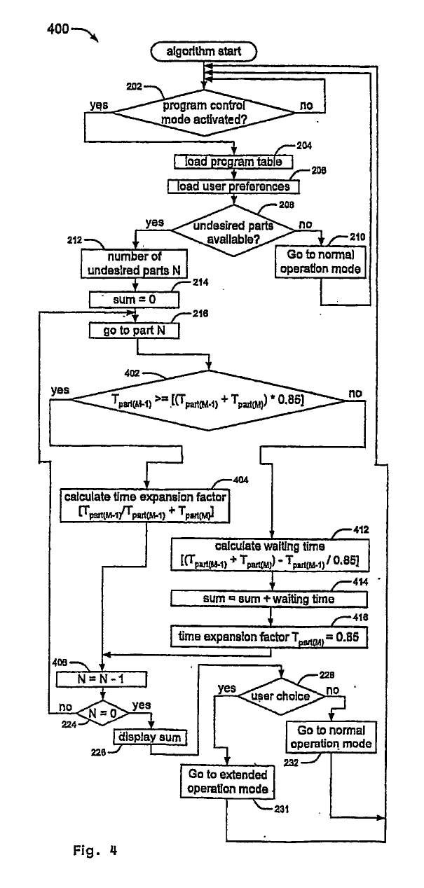

In accordance with another preferred embodiment of the invention, it is possible to reduce and even eliminate the waiting time for the user before being able to watch the desired parts of a program. FIG. 4 shows the method of FIG. 2 modified to eliminate the waiting time. This method uses audio/video data processing techniques, known to those of skill in the art, to extend some parts of the desired A/V signal. Extending the signal produces a “fictitious” time extension of the desired parts of a program until an undesired part is actually received. As a result, the time extension reduces and sometimes completely eliminates the initial waiting time for the program start. This time extended display mode does not require any additional data from the service provider and can use the same program table shown in FIG. 1b.

Since the desired program segments are to be extended, there must be a subjective extension limit under which the displayed signal is not allowed to fall. This is necessary to guarantee the quality of the displayed signal and to prevent the use from having the impression of watching slow motion video. It has been determined that a reasonable extension limit is 0.85, while the acceptable extension limit range is between 0.85 and 1.

Referring to FIG. 4, the first steps 202-216 are identical to that of FIG. 2 and will not be repeated here to prevent redundancy. Once the SUM is initialized to zero (214) and the last undesired part is gone to (216), a determination is made (402) whether T_{PART}_{_{—}}_{(M-1)}>=[(T_{PART}_{_{—(M−1)}}+T_{PART}_{_{—(M)}})*0.85] is fulfilled, where M is the undesired parts under current analysis. In the present example, T_{PART}_{_{—}}₅>=[(T_{PART}_{_{—}}₅+T_{PART}_{_{—}}₆)*0.85], which results in (9²⁰−9⁰⁰)=20>(20+1)*0.85=21*0.85=17.85. Thus, the result of this determination is YES which means that it is possible to extend part 5 by a factor greater than 0.85 to allow for removing part 6 when it is received. The user only sees the extended part 5 that additionally covers the duration of the removed part 6, and more significantly, this without having a waiting time as in the first embodiment of FIG. 2.

The exact factor for slowing down part 5 is calculated in the next step (406) where the factor is given by [T_{PART}_{_{—}}₅/(T_{PART}_{_{—}}₅+T_{PART}_{_{—}}₆)]=20/21=0.952, which is unnoticeable by the user. Once the exact extension factor is calculated for this part, the parameter N is decreased by 1 (406) and a determination is made whether N=0 (i.e., all undesired parts have been addressed by the system. If not, the SUM is displayed to the user (226) and they can determine (228) whether or not to proceed with the extended operation mode (231) or go on to normal operation mode (232). In the present example N=1 (i.e., 2−1=1) and the method continues with the next undesired part M (T_{PART}_{_{—}}₂) and make a determination whether the condition T_{PART}_{_{—}}_{(M-1)}>=[(T_{PART}_{_{—}}_{(M-1)})=T_{PART}_{_{—}}_{(M)}*0.85) is fulfilled (402). In the present example, T_{PART}_{_{—}}₁>=[(T_{PART}_{_{—}}₁+T_{PART}_{_{—}}₂)*0.85] results in (8¹⁰−8⁰⁰)=10<(10+2)*0.85=12*0.85=10.2. 10<10.2 and the determination (at step 402) is NO and means that it is not possible to extend part 1 in time by a factor greater than 0.85 to allow for removing part 2 when it is received. Therefore, extending part 1 cannot completely fill the time gap which results from removing part 2, and results in the requirement of additional waiting time. However, this waiting time is shorter than the waiting time in the embodiment disclosed in FIG. 2. This is because part 1 will be extended by a factor of 0.85.

The exact waiting time which is equal to [(T_{PART}_{_{—}}₁+T_{PART}_{_{—}}₂)−T_{PART}_{_{—}}₁/0.85] now needs to be calculated (412). In this example, this results in 12-11.765=0.235 minutes=14.1 seconds. Thus, the waiting time in the present example is only 14.1 seconds compared with the 3 minutes of the embodiment in FIG. 2. The waiting time is stored in the SUM parameter (414), thus making SUM=0+14.1=14.1 seconds. Parameter N is further reduced by 1 (406) which results in N=1−1=0.

The next determination (224) is YES and a message is displayed to the user offering them to accept or decline on the 14.1 second delayed start. If the user says NO, normal operation mode resumes, if the user says YES, then the digital TV enters the “extended display operation mode”.

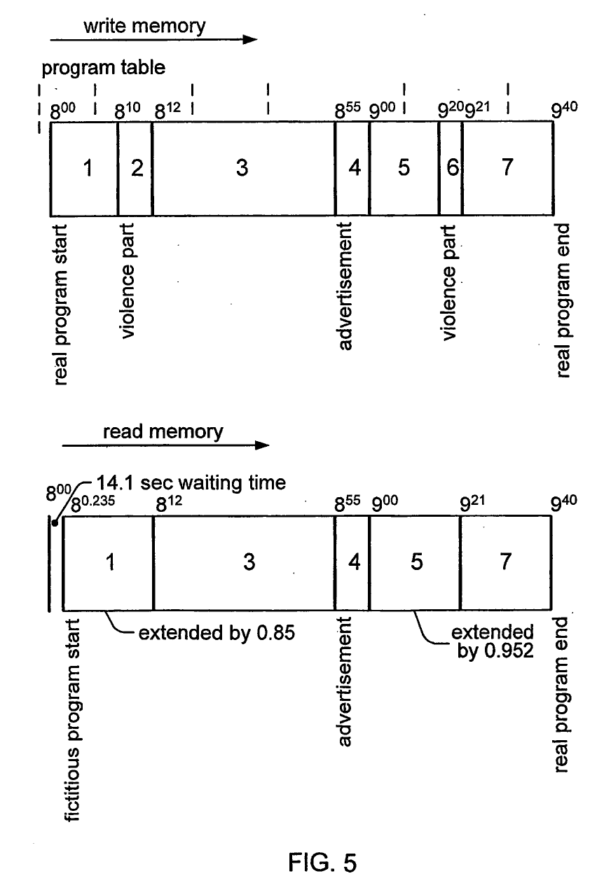

FIG. 5 shows the timing of the time extended operation using the values of the example of FIG. 1a. The initial waiting time is reduced to 14.1 seconds from 3 minutes in the delayed display mode. The viewer starts to watch the program 14.1 second later, the data is read from the memory at the start of segment 1 and displayed time extended by a factor of 0.85. Segment 2 is removed, segments 3 and 4 are displayed normally, segment 5 is extended by a factor of 0.965, segment 6 is suppressed and segment 7 is unchanged.

1. A method for suppressing undesired program segments from a broadcast program, the method comprising the steps of:
receiving program information from a service provider;
determining whether undesired program segments are present in the received program information; and
modifying the displayed program to eliminate the undesired program segments.

2. The method according to claim 1, further comprising the step of determining whether a user program control mode has been activated, wherein said steps of determining whether undesired program segments are present and modifying the displayed program are performed when the user program control mode has been activated.

3. The method according to claim 1, wherein said step of determining further comprises comparing the received program information with user defined preferences.

4. The method according to claim 1, wherein said step of modifying the displayed program comprises the steps of:
identifying how many undesired program segments are present;
calculating a time compensation factor for the undesired program segments;
delaying the start of the program for a time equal to the calculated time; and
displaying the program to the user uninterrupted with all of the undesired program segments removed.

5. The method according to claim 1, wherein said step of modifying the displayed program comprises the steps of:
identifying how many undesired program segments are present;
calculating time compensation factors for each of the undesired program segments;
extending selective desired program segments by the calculated time compensation factors; and
displaying the program to the user uninterrupted with all of the undesired program segments removed.

6. The method according to claim 4, further comprising the steps of:
displaying the calculated time compensation factor to the user;
requesting user input to confirm delayed start of the program for the time specified; wherein said steps of delaying and displaying are performed with the user confirms the delayed start of the program.

7. A method for suppressing undesired program segments from a broadcast program, the method comprising the steps of:
determining if a program control mode has been activated;
loading program information relating to the program content from the service provider when the program control mode has been activated;
identifying whether undesired program segments are present in the received program information;
calculating a time compensation factor for the undesired program segments;
delaying the start of the program for a time equal to the calculated time; and
displaying the program to the user uninterrupted with all of the undesired program segments removed.

8. The method according to claim 7, further comprising the step of returning to a normal operation mode when no undesired program segments are present in the received program information.

9. The method according to claim 7, wherein said step of identifying includes the step of comparing the loaded program information with user defined preferences.

10. The method according to claim 7, further comprising the steps of:
displaying the calculated waiting time to the user;
requesting user input to confirm delayed start of the program for the time specified, wherein said steps of delaying and displaying are performed when the user confirms the delayed start of the program.

11. The method according to claim 7, wherein said step of calculating a time compensation factor comprises:
calculating the time duration for each undesired program segment; and
adding each calculated time duration until all undesired program segments have been accounted.

12. A method for suppressing undesired program segments from a broadcast program, the method comprising the steps of:
determining if a program control mode has been activated;
loading program information relating to the program content from the service provider when the program control mode has been activated;
identifying whether undesired program segments are present in the received program information;
determining whether desired program segments can be extended to compensate for removal of the undesired program segments;
calculating a time compensation factor for removing the undesired program segments; and
displaying the program to the user uninterrupted with all of the undesired program segments removed.

13. The method according to claim 12, further comprising the step of returning to a normal operation mode when no undesired program segments are present in the received program information.

14. The method according to claim 12, wherein said step of determining further comprises the steps of:
comparing a time duration of an immediately preceding desired program segment with the fractional computation of the combined time durations of the undesired program segment and the immediately preceding desired program segment;
calculating a time extension factor when the time duration of the immediately preceding desired program is greater than or equal to the fractional computation; and
calculating a waiting time factor when the time duration of the immediately preceding desired program is less than the fractional computation.

15. The method according to claim 14, wherein said step of displaying further comprises the steps of:
extending the program segments immediately preceding the undesired program segments by the calculated time extension factor; and
delaying the start of the program for the calculated waiting time.

16. The method according to claim 15, further comprising the step of displaying the waiting time to the user; and
requesting user input to confirm delayed start of the program for the waiting time specified.
